(19) United States
(12) Patent Application Publication
(10) Pub. No.: US 2007/0139198 A1
(43) Pub. Date: Jun. 21, 2007

(54) RFID tag capable of limiting over-voltage and method for controlling over-voltage thereof

(75) Inventors: Dong-sik Shim, Suwon-si (KR); Ja-nam Ku, Yongin-si (KR); Young-hoon Min, Anyang-si (KR); Il-jong Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,564

(22) Filed: Jul. 17, 2006

(30) Foreign Application Priority Data
Dec. 15, 2005 (KR) 2005-0123874

(51) Int. Cl. G08B 13/14; H04Q 5/22; G08B 23/00

(52) U.S. Cl. 340/572.1; 340/693.1; 340/10.34

(57) ABSTRACT

Provided are an RFID tag capable of limiting an over-voltage and a method for controlling an over-voltage thereof. The RFID tag includes: an antenna unit receiving external electromagnetic waves to induce an input voltage; a voltage generator rectifying the input voltage to generate a driving voltage; a voltage limiter adaptively turned on and/or off depending on whether the input voltage is high or low to limit an intensity of the input voltage input into the voltage generator; and a logic controller controlling the antenna unit to generate authentication information based on the driving voltage and transmit the authentication information.

### CROSS-REFERENCE TO RELATED APPLICATIONS

This application claims priority from Korean Patent Application No. 10-2005-0123874, filed Dec. 15, 2005 in the Korean Intellectual Property Office, the entire contents of which are incorporated herein by reference.

### BACKGROUND OF THE INVENTION

1. Field of the Invention

The present invention relates to a radio frequency identification (RFID) tag capable of controlling an over-voltage and a method for controlling an over-voltage thereof, and more particularly, to an RFID tag capable of limiting an intensity of a voltage flowing into a rectifier by connecting at least one Schottky diode to the rectifier in parallel and a method for controlling an over-voltage thereof.

2. Description of the Related Art

An RFID system is a automatic identification and data capture (ADC) technology which allows RFID readers and RFID tags to exchange signals with one another. In other words, if an RFID tag reaches within a predetermined distance of an RFID reader, the RFID tag reflects a signal in response to an RF signal, and the RFID reader receives and checks the reflected signal.

Here, the RFID tag induces a voltage from electromagnetic waves transmitted from the RFID reader so as to perform the above-described operation. However, the induced voltage may vary with a distance between the RFID reader and the RFID tag, and the RFID tag may malfunction due to the variation in the voltage.

In particular, in a case where the RFID reader and the RFID tag are approaching each other, the RFID tag receives a very strong RF signal thereby inducing a large voltage. Thus, elements inside the RFID tag, for example, an RF interface generating authentication information as an RF signal and a control logic, may malfunction.

A conventional RFID tag uses a reverse Schottky diode to solve the above-described problems. FIGS. 1A and 1B are graphs illustrating a relationship between a current (I) and a voltage (V) of a reverse Schottky diode of a conventional RFID tag.

As shown in FIG. 1A, the reverse Schottky diode bypasses an alternating power greater than a breakdown voltage BV to prevent an over-alternating power from flowing into a rectifier.

In other words, the conventional RFID tag bypasses an over-alternating power using a reverse Schottky diode having a breakdown voltage BV with a predetermined value or less, for example, about 9.6V as shown in FIG. 1A. Here, a well density of the reverse Schottky diode must be kept at 10¹⁸ cm⁻³ or more so that a breakdown voltage BV′ is lower than the breakdown voltage BV as shown in FIG. 1B. However, a standard process cannot contribute to maintaining the well density in the conventional RFID tag as described above. Thus, an additional process must be performed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present general inventive concept is to provide an RFID tag capable of limiting and rectifying an over-voltage induced from an RFID reader without using a reverse Schottky diode requiring an additional precise process and a method for controlling an over-voltage thereof.

According to an aspect of the present invention, there is provided an RFID (radio frequency identification) tag for controlling an over-voltage, including: an antenna unit receiving external electromagnetic waves to induce an input voltage; a voltage generator rectifying the input voltage to generate a driving voltage; a voltage limiter adaptively turned on and/or off depending on whether the input voltage is high or low to limit an intensity of the input voltage input into the voltage generator; and a logic controller controlling the antenna unit to generate authentication information based on the driving voltage and transmit the authentication information.

The voltage limiter may be a circuit including one or more Schottky diodes to which the input voltage is equally distributed. The at least one or more Schottky diodes may be connected to one another forward in series.

If the distributed voltage is lower than a turn-on voltage of the at least one or more Schottky diodes, the one or more Schottky diodes may be turned off so as to provide a whole portion of the input voltage to the voltage generator.

If the distributed voltage is higher than the turn-on voltage of the at least one or more Schottky diodes, the one or more Schottky diodes may be turned on so as to allow a current corresponding to the distributed voltage to flow into a ground node and reduce the intensity of voltage input into the voltage generator.

If the distributed voltage is higher than the turn-on voltage of the one or more Schottky diodes, the voltage limiter may allow a relatively large amount of the current to flow into the ground node with a decrease in a number of Schottky diodes.

The voltage generator and the voltage limiter may be connected to each other in parallel. The one or more Schottky diodes may operate as ESD (electronic static discharge) elements.

According to another aspect of the present invention, there is provided a method for controlling an over-voltage of an RFID tag, including: (a) receiving external electromagnetic waves to induce an input voltage; (b) adaptively turning on and/or off one or more Schottky diodes depending on whether the input voltage is high or low to limit an intensity of the input voltage; (c) rectifying the input voltage to generate a driving voltage; and (d) generating authentication information based on the driving voltage and transmitting the authentication information,to an outside.

In step (b), the input voltage may be equally distributed to the one or more Schottky diodes, and then the at least one or more Schottky diodes may be turned on and/or off depending on whether the distributed voltage is high or low.

The one or more Schottky diodes may be connected to one another forward in series.

In step (b), if the distributed voltage is lower than a turn-on voltage of the one or more Schottky diodes, the one or more Schottky diodes may be turned off so as to rectify a whole portion of the induced input voltage in step (c).

In step (b), if the distributed voltage is higher than the turn-on voltage of the one or more Schottky diodes, the one or more Schottky diodes may be turned on so as to allow a current corresponding to the distributed voltage to flow into a ground node and reduce an intensity of voltage input to the step (c).

### BRIEF DESCRIPTION OF THE DRAWINGS

The above and other aspects of the present invention will become more apparent by describing certain exemplary embodiments of the present invention with reference to the accompanying drawings, in which:

FIGS. 1A and 1B are graphs illustrating a relationship between a current I and a voltage V of a reverse Schottky diode of a conventional RFID tag;

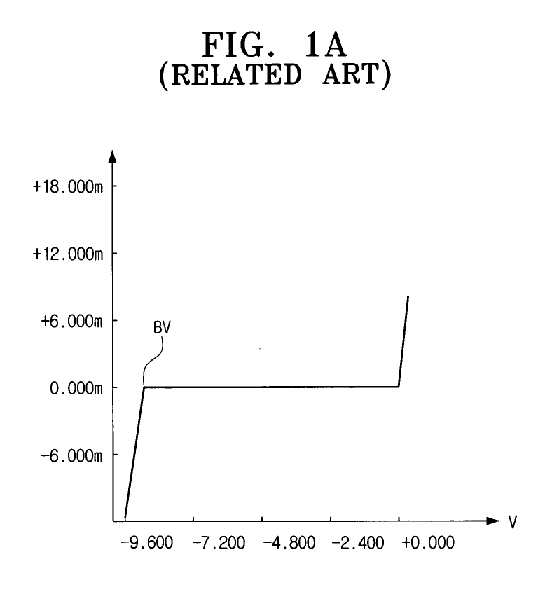

FIG. 2 is a schematic block diagram of an RFID tag according to an exemplary embodiment of the present invention;

FIG. 3 is a graph illustrating a relationship between a current I and a voltage V of a Schottky diode of a voltage limiter shown in FIG. 2; and

FIG. 4 is a flowchart of a method for controlling an over-voltage of an RFID tag shown in FIG. 2 according to an exemplary embodiment of the present invention.

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The matters defined herein are described at a high-level of abstraction to provide a comprehensive yet clear understanding of the invention. It is also to be noted that it will be apparent to those ordinarily skilled in the art that the present invention is not limited to the description of the exemplary embodiments provided herein.

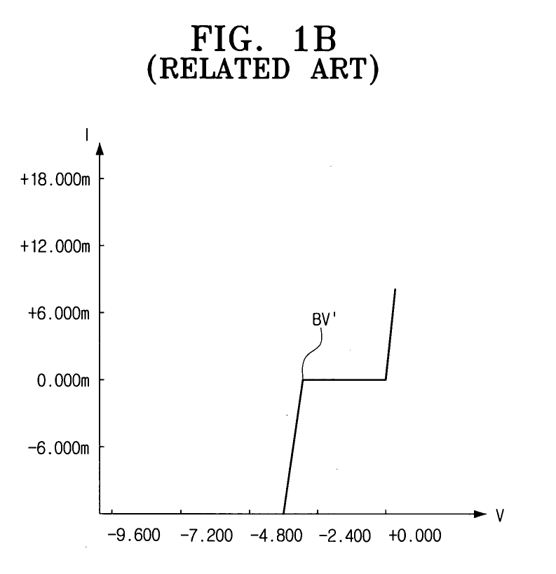

FIG. 2 is a schematic block diagram of an RFID tag capable of controlling an over-voltage according to an exemplary embodiment of the present invention.

An RFID tag 200 according to the present exemplary embodiment performs an authentication process with an RFID reader (not shown) wirelessly. If the RFID tag 200 is positioned within a predetermined range, the RFID tag 200 receives electromagnetic waves from the RFID reader to generate authentication information, and the RFID reader receives the authentication information to perform the authentication process.

Referring to FIG. 2, the RFID tag 200 includes an antenna unit 210, a voltage limiter 220, a voltage generator 230, a storage 240, and a logic controller 250.

The antenna unit 210 receives the electromagnetic waves from the RFID reader to induce an input voltage Vᵢₙ. For this purpose, the antenna unit 210 may be formed in various forms such as a loop antenna, a coil formed of a conductive material, or the like. The antenna unit 210 includes first and second metals 212 and 214. The first metal 212 receives the electromagnetic waves to induce the input voltage Vᵢₙ, and the second metal 214 operates as a ground node. The sensitivity of the electromagnetic waves varies with a distance between the RFID reader and the RFID tag 200. In other words, as the distance between the RFID reader and the RFID tag 200 decreases, the antenna unit 210 induces a high voltage.

The voltage limiter 220 is adaptively turned on or off depending on whether the input voltage Vᵢₙ induced by the antenna unit 210 is high or low so as to limit an intensity of Vₒᵤₜ input into the voltage generator 230.

The voltage limiter 220 may include at least one Schottky diode. In the present exemplary embodiment, the first through n^{th} Schottky diodes SD₁, SD₂, . . . , and SDₙ (n is an integer) will be taken as examples. The first through n h Schottky diodes SD₁, SD₂, . . . , and SDₙ are connected to one another forward in series, and a cathode of the nth Schottky diode SDₙ provides a current moving path to a ground node, i.e., the second metal 214. The first through n^{th} Schottky diodes SD₁, SD₂, . . . , and SDₙ have the same characteristics and thus have an identical turn-on voltage V_{TO}.

A Schottky diode uses a Schottky barrier that is a function of connecting a conductor to a P-type or N-type semiconductor to barrier a reverse voltage on a contact surface between the conductor and the P-type or N-type semiconductor. The Schottky diode has a lower forward turn-on voltage V_{TO} than a general rectifier diode and thus is suitable for a high frequency rectifier circuit.

A number of Schottky diodes used in the voltage limiter 220 is not limited and may be determined based on a maximum communication distance between the RFID reader and the RFID tag 200. In other words, the output voltage Vₒᵤₜ from the voltage limiter 220 finally input into the voltage generator 230 is controlled depending on the number of Schottky diodes of the voltage limiter 220.

In more detail, the voltage Vᵢₙ induced by the antenna unit 210 is equally distributed to the first through nth Schottky diodes SD₁, SD₂, . . . , and SDₙ. If the intensity of the distributed voltage is lower than an intensity of the turn-on voltage V_{TO}, the first through n^{th} Schottky diodes SD₁, SD₂, . . . , and SDₙ are turned off so as to provide all of the voltage Vᵢₙ to the voltage generator 230.

If the intensity of the distributed voltage is higher than the intensity of the turn-on voltage V_{TO}, the first through n^{th} Schottky diodes SD₁, SD₂, . . . , and SDₙ are turned on so as to allow a current to flow into the second metal 214. Thus, the first through n^{th} Schottky diodes SD₁, SD₂, . . . , and SDₙ, consume power by an amount of the current flowing into the second metal 214 so as to limit the intensity of a voltage provided to the voltage generator 230.

In particular, if the intensity of the distributed voltage is higher than the intensity of the turn-on voltage V_{TO}, the voltage limiter 220 allows a large amount of current to flow into the second metal 214 with a decrease in the number of Schottky diodes of the voltage limiter 220.

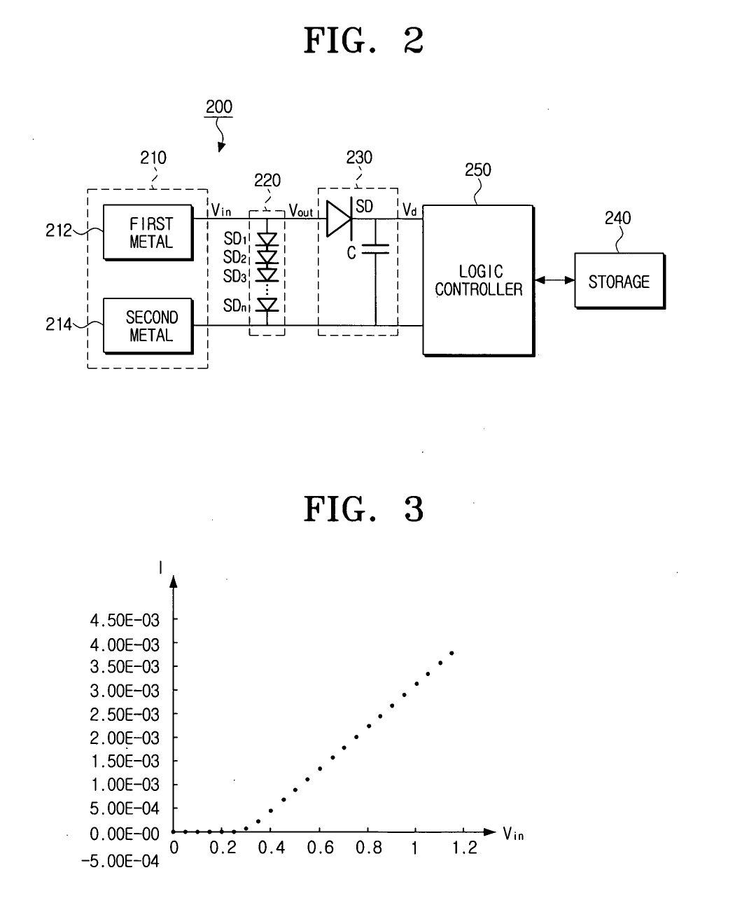

Each of the first through n^{th} Schottky diodes SD₁, SD₂, . . . , and SDₙ has a current I and voltage V relationship as shown in FIG. 3. Since the first through n^{th} Schottky diodes SD₁, SD₂, . . . , and SDₙ are connected to one another forward, only forward I-V characteristics are shown in FIG. 3. As shown in FIG. 3, a value of the turn-on voltage V_{TO} at which a current greatly rises may vary with a type or manufacturing characteristic of a conductor contacting a surface of a semiconductor.

Referring to FIGS. 2 and 3, the turn-on voltage V_{TO} is about 0.2V, and thus the first through n^{th} Schottky diodes SD₁, SD₂, . . . , and SDₙ are turned off at a voltage of about 0.2V or less but turned on at a voltage of about 0.2V or more so as to allow a current to flow from an anode toward a cathode.

In a case where the input voltage Vᵢₙ induced by the antenna unit 210 is 5V and the voltage limiter 220 includes five Schottky diodes, a voltage of 1V is distributed to each of the five Schottky diodes. Thus, the five Schottky diodes are turned on so as to flow a current of about 4.00×10⁻³A corresponding to 1V into the second metal 214. As a result, the voltage limiter 220 consumes a power or voltage of about 4.00×10⁻³ A so as to apply a voltage lower than 6V to the voltage generator 230.

In a case where the input voltage Vᵢₙ induced by the antenna unit 210 is 1V and the voltage limiter 220 includes five Schottky diodes, a voltage of 0.2V is distributed to each of the five Schottky diodes. Thus, the five Schottky diodes are turned off. As result, the voltage limiter 220 does not consume a power so as to apply the input voltage Vᵢₙ of 1V to the voltage generator 230.

The voltage limiter 220 according to an exemplary embodiment of the present invention limits a voltage and operates as an electronic static discharge (ESD) element. ESD means discharge caused by static electricity, and the ESD element passes only a signal necessary for protecting a semiconductor sensitive to static electricity but removes an unnecessary signal.

The voltage generator 230 rectifies a portion or the whole portion of the input voltage Vᵢₙ input from the antenna unit 210 to generate a driving voltage V_{d}. For this purpose, the voltage generator 230 includes a combination of a Schottky diode SD and a capacitor C. Since a general diode is not suitable to be used in a high frequency band, the voltage generator 230 may use the Schottky diode SD to realize a rectifier circuit.

The driving voltage V_{d} generated by the voltage generator 230 is used to drive internal elements such as the storage 240 and the logic controller 250.

The storage 240 stores the authentication information necessary for the authentication process and a control program. If an object to which the RFID tag 200 is attached is a person, the authentication information may be information as to a name, a birth date, an identity, and the like. If the object is an article, the authentication information may be information as to a type, a manufacturing date, a class, and the like of the article.

If the authentication information is generated based on the driving voltage V_{d} generated by the voltage generator 230, the logic controller 250 controls the antenna unit 210 to transmit the authentication information to the RFID reader. In more detail, the logic controller 250 extracts the authentication information necessary for the authentication process from the storage 240, generates an RF type transmission signal, and transmits the RF type transmission signal to the RFID reader through the antenna unit 210.

In the RFID tag 200 according to an exemplary embodiment of the present invention, the voltage limiter 220 can use a forward Schottky diode to prevent an over-voltage from being applied to the voltage generator 230 so as to reduce instances where elements of the RFID tag 200 malfunction.

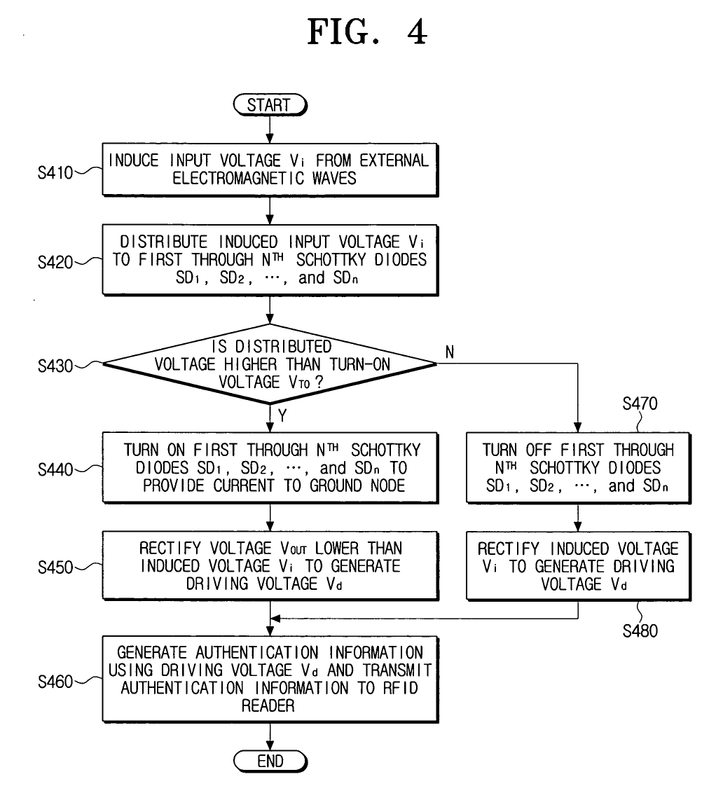

FIG. 4 is a flowchart of a method for controlling an over-voltage of the RFID tag 200 shown in FIG. 2 according to an exemplary embodiment of the present invention. Referring to FIGS. 2 and 4, if the RFID tag 200 is positioned within the range of the RFID reader (not shown), the antenna unit 210 receives the electromagnetic waves from the RFID reader to induce the input voltage Vᵢ in operation S410. Here, as the distance between the RFID tag 200 and the RFID reader is close, the antenna unit 210 receives electrostatic waves having high reception sensitivity and thus induces a high voltage.

In operation S420, the input voltage Vᵢ is equally distributed to the first through n^{th} Schottky diodes SD₁, SD₂, . . . , and SDₙ. For example, if the input voltage Vᵢ is 1V and ten Schottky diodes exist, a voltage of 0.1V is distributed to each of the first through n^{th} Schottky diodes SD₁, SD₂, . . . , and SDₙ.

In operation S430, a determination is made as to whether the distributed voltage is higher than the turn-on voltage V_{TO} set in the first through n^{th} Schottky diodes SD₁, SD₂, . . . , and SDₙ. If it is determined in operation S430 that the distributed voltage is higher than the set turn-on voltage V_{TO}, the first through n^{th} Schottky diodes SD₁, SD₂, . . . , and SDₙ are turned on so as to allow the current corresponding to the distributed voltage to flow into the second metal 214 in operation S440. Thus, the first through n^{th} Schottky diodes SD₁, SD₂, . . . , and SDₙ consume power by the amount of the current flowing into the second metal 214 so as to limit the intensity of the voltage provided to the voltage generator 230. According to the result of operation S440, a voltage V_{OUT} lower than the input voltage Vᵢ flows into the voltage generator 230.

In operation S450, the voltage generator 230 rectifies the voltage V_{OUT} to generate the driving voltage V_{d}. In operation S460, the logic controller 250 generates the authentication information based on the driving voltage V_{d} and transmits the authentication information to the RFID reader.

If it is determined in operation S430 that the distributed voltage is lower than the turn-on voltage V_{TO}, in operation S470 the first through n^{th} Schottky diodes SD₁, SD₂, . . . , and SDₙ are turned off so as to provide the input voltage Vᵢ to the voltage generator 230. In other words, Vᵢ equals V_{OUt}.

In operation S480, the voltage generator 230 rectifies the input voltage Vᵢ to generate the driving voltage V_{d}. The logic controller 250 performs operation S460 using the driving voltage V_{d} generated in operation S480.

As described above, in an RFID tag capable of limiting an over-voltage and a method for controlling an over-voltage thereof, a rectifier rectifying an induced voltage can be connected to at least one or more Schottky diodes in parallel, and the at least one or more Schottky diodes can be connected to one another forward in series. Thus, an induced over-voltage can be prevented from flowing into the rectifier.

In particular, forward Schottky diodes can be used, and thus a process of adding a reverse Schottky diode does not need to be performed. Thus, cost can be reduced.

Also, a limited amount of a voltage to be rectified can be easily controlled depending on the number of forward Schottky diodes.

In addition, the forward Schottky diodes can be adaptively turned on or off depending on an intensity of the induced voltage. In particular, in a case where a low voltage is applied, a plurality of Schottky diodes connected to one another in series can be turned off to have great impedance. Since the plurality of Schottky diodes are open, the low voltage can be prevented from being lost and can be further efficiently rectified.

Moreover, the at least one or more forward Schottky diodes can limit voltage and operate as ESD elements.

The foregoing embodiments are merely exemplary in nature and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A radio frequency identification (RFID) tag for controlling an over-voltage, comprising:
a voltage generator which rectifies an input voltage from an antenna to generate a driving voltage;
a voltage limiter adaptively turned on and/or off depending on whether the input voltage is high or low to limit an intensity of the input voltage input into the voltage generator; and
a logic controller which generates authentication information based on the driving voltage.

2. The RFID tag of claim 1, further comprising the antenna, wherein the antenna receives electromagnetic waves to induce the input voltage and the controller controls the antenna to transmit the authentication information.

3. The RFID tag of claim 1, wherein the voltage limiter is a circuit comprising one or more Schottky diodes to which the input voltage is equally distributed.

4. The RFID tag of claim 3, wherein the one or more Schottky diodes are connected to one another forward in series.

5. The RFID tag of claim 3, wherein if the distributed voltage is lower than a turn-on voltage of the one or more Schottky diodes, the one or more Schottky diodes are turned off to provide a whole portion of the input voltage to the voltage generator.

6. The RFID tag of claim 3, wherein if the distributed voltage is higher than the turn-on voltage of the one or more Schottky diodes, the at least one or more Schottky diodes are turned on to allow a current corresponding to the distributed voltage to flow into a ground node and reduce the intensity of voltage input into the voltage generator.

7. The RFID tag of claim 6, wherein if the distributed voltage is higher than the turn-on voltage of the one or more Schottky diodes, the voltage limiter allows the current to flow into the ground node, the current increasing with a decrease in the number of Schottky diodes.

8. The RFID tag of claim 1, wherein the voltage generator and the voltage limiter are connected to each other in parallel.

9. The RFID tag of claim 3, wherein the one or more Schottky diodes operate as electronic static discharge (ESD) elements.

10. A method for controlling an over-voltage of an RFID tag, comprising:
(a) receiving external electromagnetic waves to induce an input voltage;
(b) adaptively turning on and/or off at least one or more Schottky diodes depending on whether the input voltage is high or low to limit an intensity of the input voltage;
(c) rectifying the input voltage to generate a driving voltage; and
(d) generating authentication information based on the driving voltage and transmitting the authentication information.

11. The method of claim 9, wherein in operation (b), the input voltage is equally distributed to the one or more Schottky diodes, and the one or more Schottky diodes are turned on and/or off depending on whether the distributed voltage is high or low.

12. The method of claim 11, wherein the one or more Schottky diodes are connected to one another forward in series.

13. The method of claim 11, wherein in the operation (b), if the distributed voltage is lower than a turn-on voltage of the one or more Schottky diodes, the one or more Schottky diodes are turned off to induce a whole portion of the rectified input voltage in operation (c).

14. The method of claim 11, wherein in the operation (b), if the distributed voltage is higher than the turn-on voltage of the one or more Schottky diodes, the one or more Schottky diodes are turned on to allow a current corresponding to the distributed voltage to flow into a ground node and reduce an intensity of voltage input to operation (c).

15. The method of claim 10, wherein the one or more Schottky diodes operate as electronic static discharge (ESD) elements.
